(19) United States
(12) Patent Application Publication
(10) Pub. No.: US 2014/0016703 A1
(43) Pub. Date: Jan. 16, 2014

(54) METHODS AND DEVICES FOR CONTROLLING SPATIAL ACCESS GRANULARITY IN COMPRESSED VIDEO STREAMS

(71) Applicant: CANON KABUSHIKI KAISHA, Tokyo (JP)

(72) Inventor: FRANCK DENOUAL, SAINT DOMINEUC (FR)

(21) Appl. No.: 13/937,466

(22) Filed: Jul. 9, 2013

(30) Foreign Application Priority Data
Jul. 11, 2012 (GB) 1212360.0

(51) Int. Cl. H04N 7/36

(52) U.S. Cl. CPC H04N 19/00696
USPC 375/240.16; 375/240.12

(57) ABSTRACT

The present invention provides methods and devices for controlling spatial access granularity in images of video streams compressed according to a block-based scalable video format. Encoded images comprise an encoded base layer and at least one encoded enhancement layer. According to an embodiment of the invention, relevant blocks are determined in the encoded base layer according to a given criterion that depends on video data. The at least one enhancement layer is encoded into at least two distinct groups of blocks independently decodable, or partially decoded, as a function of at least one item of information representative of the determined relevant blocks.

This application claims the benefit under 35 U.S.C. §119(a)-(d) of United Kingdom Patent Application No. 1212360.0, filed on Jul. 11, 2012 and entitled “Methods and devices for controlling spatial access granularity in compressed video streams”. The above cited patent application is incorporated herein by reference in its entirety.

### FIELD OF THE INVENTION

The present invention relates to methods and devices for controlling spatial access granularity in compressed video streams. The invention further concerns methods and devices for encoding or decoding a sequence of digital images.

### BACKGROUND OF THE INVENTION

The invention may be applied in the field of digital signal processing, and in particular in the field of video compression to provide random spatial access features. It may be used in conjunction with any block-based scalable video codec for applications providing access to spatial areas of ultra-high definition video streams for transmission and/or display purposes. More specifically it is directed to bit-stream organization that provides content-adaptive spatial access.

Future video cameras will be able to capture ultra-high definition (UHD) images for producing digital video streams that have to be compressed to be stored or transmitted efficiently. The image definition of a UHD video stream is typically four times the image definition of a HD video stream which is the current standard definition for video stream. Sixteen times this definition is even considered in a more distant future.

Depending on the use case scenario, the video encoder may be embedded in a portable device, such as a digital video camera or a camcorder. In such a case, the video encoder should encode UHD video streams in real-time while limiting power consumption. It should also minimize memory access bandwidth because of limited bandwidth on small chips. Regarding video stream decoding and displaying, certain portable devices having limited display capabilities, for example HD compatible displays, may only decode and display spatial parts of UHD video streams.

Therefore, the emergence of video encoders encoding ultra-high definition video streams combined with the proliferation of display devices having different screen resolutions requires adapters, in particular adapters allowing selection of spatial areas of encoded images. Moreover, it is observed that such devices should generally be based on rich user interfaces providing, for example, clickable video functions accessible through Web pages or Web applications, also requiring adapters allowing selection of spatial areas of encoded images. As an example, direct application of clickable video relates to the possibility given to users to click on a video frame area to zoom-in on the video in order to get high quality video on a particular region of interest (ROI).

A known UHD codec uses current technologies allowing encoding of HD video streams in embedded devices to encode a first reduced version of a video stream of the HD resolution with a standard existing codec (e.g. H.264 or HEVC format) to obtain a base layer. Next, it encodes the pixel differences between an up-scaled version of an encoded HD image and the corresponding original UHD image to obtain an enhancement layer. According to this UHD codec, the enhancement layer is organized in a way that provides spatial access, enabling extraction and decoding of spatial areas without requiring decoding of the whole bit-stream.

It should be noted that this UHD codec encodes images of the enhancement layer only as Intra frames (i.e. as images whose decoding can be performed independently of previous and/or following images). Accordingly, the elimination of Inter frame prediction between images of the enhancement layer leads to a drastic increase of memory bandwidth consumption and to the elimination of temporal dependencies between the blocks from one frame to another.

One may even go further by elimination of Intra block prediction within each frame of the enhancement layer. This would make blocks independent from one another and potentially decodable on an individual basis, thus facilitating spatial random access.

However, Inter frame and Intra block predictions are known to be powerful video compression tools and it would appear impossible to satisfy compression needs without using such mechanisms.

An algorithm known as max-shift in JPEG2000 allows ROI encoding so that the ROI can be decoded before the background in resolution and quality progressions and the background can be truncated in rate allocation before the ROI. To that end, a wavelet transformation is applied to pixels and the so-obtained wavelet coefficients are quantized. The coefficients pertaining to the region of interest are shifted to become the most significant coefficients that are encoded and decoded first. In JPEG-2000, the coefficients are decomposed into regular code-blocks and the code-block coordinates as well as the data organization is given in packet headers. ROI correspond to fixed and predetermined areas.

In the article entitled “Scalable ROI algorithm for H.264/SVC based video streaming”, Lee and Yoo, IEEE Transactions on Consumer Electronics, Vol 57, No. 2. May 2011, the authors present a solution consisting of applying the ROI concept to SVC (Scalable Video Coding) with SNR (Signal-to-Noise Ratio) scalability. According to the disclosure, an ROI area can be predetermined, defined by the user, or determined as a function of image analysis, for example based on blocks having high motion. The so-defined ROI is encoded using FMO (Flexible Macroblock Ordering) and slice groups. Initially designed for concealment in error-prone channels, the FMO specifies a pattern that assigns the blocks from a frame to one or several slice groups. According to FMO, no spatial predictor is used from one slice group to another. However, it does not prevent a block inside a region of interest from referencing a block outside this region of interest in one or more past reference frames.

In this system, a decision engine is used during transmission to determine the decoding scheme to be used with respect to network conditions. The first decoding scheme is a standard one bringing incremental quality to the whole image while the second decoding scheme aims at bringing incremental quality only to the region of interest and the third one is a mix between the first two. The organization of the enhancement layer is defined in the encoding parameters of the base layer.

The present invention has been devised to address one or more of the foregoing concerns and, in particular, to provide a content-adaptive spatial access efficiently compressed video stream.

### SUMMARY OF THE INVENTION

According to a first aspect of the invention there is provided a method for encoding at least one image of a video stream in a block-based scalable video format, the encoded image comprising an encoded base layer and at least one encoded enhancement layer, the method comprising:
determining relevant blocks in the encoded base layer according to a given criterion that depends on video data; and
encoding the at least one enhancement layer into at least two distinct groups of blocks independently decodable, as a function of at least one item of information representative of the determined relevant blocks.

According to this first aspect of the invention, there is provided simple, efficient and block based entropy coding with adaptive organization of the quantized DCT coefficients. The absence of intra prediction between blocks and the judicious choice of data organization for the entropy coding provides random spatial access into the video bit-stream. In other words, the bit-stream can be decoded from any entry point in the stream because the decoding does not depend on the decoding of the preceding parts of the stream.

According to a particular embodiment of the invention, the method further comprises a step of generating a relevance map based on the determined relevant blocks, the at least one item of information representative of the determined relevant blocks comprising the generated relevance map.

Still according to a particular embodiment of the invention, the step of determining relevant blocks comprises a step of obtaining the size of at least one block of the base layer, the at least one block whose size is obtained being considered as relevant or not as a function of the obtained size. Such a method is particularly adapted to the Intra coding mode.

Still according to a particular embodiment of the invention, the step of determining relevant blocks comprises a step of obtaining at least one motion vector of at least one block of the base layer, the at least one block whose motion vector is obtained being considered as relevant or not as a function of the obtained motion vector. Such a method is particularly adapted to the Inter coding mode.

Still according to a particular embodiment of the invention, the step of determining relevant blocks comprises a step of estimating at least one residual value based on the at least one block whose motion vector is obtained and on at least one predicted block based on the at least one obtained motion vector. Such a method is particularly adapted to the case according to which the motion vector is estimated on a rate-distortion basis.

Still according to a particular embodiment, the step of estimating at least one residual value is performed as a function of a type of motion estimation applied to the at least one block whose motion vector is obtained. The type of motion estimation may be encoded as a flag within the video stream.

Still according to a particular embodiment of the invention, the step of determining relevant blocks comprises a step of comparing at least one obtained motion vector with statistical motion data relating to the image to be encoded. The statistical motion data may comprise a mean value and a standard deviation of motion values of each of a plurality of blocks of the image to be encoded. Such a method is particularly adapted to the case according to which the motion vector characterizes a real motion.

Still according to a particular embodiment of the invention, the method further comprises a step of up-sampling the generated relevance map to encode the at least one enhancement layer into at least two distinct groups of blocks independently decodable.

Still according to a particular embodiment of the invention, the step of generating a relevance map comprises a step of creating at least one region of interest comprising a set of relevant blocks. The method may further comprise a step of expanding the at least one region of interest as a function of a minimum size and/or a step of discarding at least one generated region of interest that is contained within at least one bigger generated region of interest.

Still according to a particular embodiment of the invention, the step of encoding the at least one enhancement layer comprises a first step of encoding blocks that do not correspond to any region of interest of the relevance map and at least one second step of encoding blocks that correspond to at least one region of interest of the relevance map.

According to a second aspect of the invention there is provided a method for decoding at least one image of a video stream in a block-based scalable video format, the encoded image comprising an encoded base layer and at least one encoded enhancement layer, the method comprising:
determining relevant blocks in the base layer according to a given criterion that depends on video data; and
decoding at least a part of the at least one enhancement layer as a function of at least one item of information representative of the determined relevant blocks.

According to this second aspect of the invention, it is provided a spatial random access to an encoded video stream, with a reduced overhead in terms of bitrate and without requiring the decoding of the whole stream.

According to a particular embodiment of the invention, the method further comprises a step of generating a relevance map based on the determined relevant blocks, the at least one item of information representative of the determined relevant blocks comprising the generated relevance map.

Still according to a particular embodiment of the invention, the step of determining relevant blocks comprises a step of obtaining the size of at least one block of the base layer, the at least one block whose size is obtained being considered as relevant or not as a function of the obtained size. Such a method is particularly adapted to the Intra decoding mode.

Still according to a particular embodiment of the invention, the step of determining relevant blocks comprises a step of obtaining at least one motion vector of at least one block of the base layer, the at least one block whose motion vector is obtained being considered as relevant or not as a function of the obtained motion vector. Such a method is particularly adapted to the Inter decoding mode.

Still according to a particular embodiment of the invention, the step of determining relevant blocks comprises a step of estimating at least one residual value based on the at least one block whose motion vector is obtained and on at least one predicted block based on the at least one obtained motion vector. Such a method is particularly adapted to the case according to which the motion vector is estimated on a rate-distortion basis.

Still according to a particular embodiment, the step of estimating at least one residual value is performed as a function of a type of motion estimation applied to the at least one block whose motion vector is obtained. The type of motion estimation may be encoded as a flag within the video stream.

Still according to a particular embodiment of the invention, the step of determining relevant blocks comprises a step of comparing at least one obtained motion vector with statistical motion data relating to the image to be decoded. The statistical motion data may comprise a mean value and a standard deviation of motion values of each of a plurality of blocks of the image to be encoded. Such a method is particularly adapted to the case according to which the motion vector characterizes a real motion.

Still according to a particular embodiment of the invention, the method further comprises a step of up-sampling the generated relevance map to decode the at least a part of the at least one enhancement layer.

The step of generating a relevance map advantageously comprises a step of creating at least one region of interest comprising a set of relevant blocks. The method may further comprise a step of expanding the at least one region of interest as a function of a minimum size and/or a step of discarding at least one generated region of interest that is contained within at least one bigger generated region of interest.

According to a third aspect of the invention there is provided a method for streaming video data from a sending device to a receiving device, the video data being encoded in a block-based scalable video format, the video data comprising at least one encoded image comprising a base layer and at least one enhancement layer, the method comprising:
receiving at least the encoded base layer from the sending device;
determining relevant blocks in the encoded base layer according to a given criterion that depends on video data; and
determining at least one selectable area in the base layer as a function of at least one item of information representative of the determined relevant blocks, allowing a user of the receiving device to obtain enhancement layer data from the enhancement layer corresponding the determined selectable area.

According to this third aspect of the invention, there is provided an efficient method for decoding video streams, offering spatial random access to the encoded video stream, with a reduced overhead in terms of bitrate and without requiring the decoding of the whole stream. Such method for streaming video data is particularly adapted for the broadcast of video streams to devices having different display capabilities and/or offering video interaction functions to users.

According to a particular embodiment of the invention, the method further comprises a step of generating a relevance map based on the determined relevant blocks, the at least one item of information representative of the determined relevant blocks comprising the generated relevance map.

Still according to a particular embodiment of the invention, the step of determining relevant blocks comprises a step of obtaining the size of at least one block of the base layer, the at least one block whose size is obtained being considered as relevant or not as a function of the obtained size. Such a method is particularly adapted to the Intra decoding mode.

Still according to a particular embodiment of the invention, the step of determining relevant blocks comprises a step of obtaining at least one motion vector of at least one block of the base layer, the at least one block whose motion vector is obtained being considered as relevant or not as a function of the obtained motion vector. Such a method is particularly adapted to the Inter decoding mode.

Still according to a particular embodiment of the invention, the step of determining relevant blocks comprises a step of estimating at least one residual value based on the at least one block whose motion vector is obtained and on at least one predicted block based on the at least one obtained motion vector. Such a method is particularly adapted to the case according to which the motion vector is estimated on a rate-distortion basis.

Still according to a particular embodiment, the step of estimating at least one residual value is performed as a function of a type of motion estimation applied to the at least one block whose motion vector is obtained. The type of motion estimation may be encoded as a flag within the video stream.

Still according to a particular embodiment of the invention, the step of determining relevant blocks comprises a step of comparing at least one obtained motion vector with statistical motion data relating to the image to be decoded. The statistical motion data may comprise a mean value and a standard deviation of motion values of each of a plurality of blocks of the image to be encoded. Such a method is particularly adapted to the case according to which the motion vector characterizes a real motion.

Still according to a particular embodiment of the invention, the method further comprises a step of up-sampling the generated relevance map for decoding the enhancement layer data.

Still according to a particular embodiment of the invention, the step of generating a relevance map comprises a step of creating at least one region of interest comprising a set of relevant blocks. The method may further comprise a step of expanding the at least one region of interest as a function of a minimum size and/or of discarding at least one generated region of interest that is contained within at least one bigger generated region of interest.

According to another aspect of the invention, there is provided a computer program for a programmable apparatus, the computer program comprising instructions for carrying out each step of the method according to any one of the first, second, and third aspect of the invention when the program is loaded and executed by a programmable apparatus.

According to another aspect of the invention, there is provided a computer-readable storage medium storing instructions of a computer program for carrying out each step of the method according to any one of the first, second, and third aspect of the invention.

According to another aspect of the invention, there is provided a device for encoding at least one image of a video stream in a block-based scalable video format, the encoded image comprising an encoded base layer and at least one encoded enhancement layer, the device comprising:
determining means for determining relevant blocks in the encoded base layer according to a given criterion that depends on video data; and
encoding means for encoding the at least one enhancement layer into at least two distinct groups of blocks independently decodable, as a function of at least one item of information representative of determined relevant blocks.

According to this aspect of the invention, there is provided simple, efficient and block based entropy coding with adaptive organization of the quantized DCT coefficients. The absence of intra prediction between blocks and the judicious choice of data organization for the entropy coding provides random spatial access into the video bit-stream. In other words, the bit-stream can be decoded from any entry point in the stream because the decoding does not depend on the decoding of the preceding parts of the stream.

According to a particular embodiment of the invention, the device further comprises generating means for generating a relevance map based on determined relevant blocks, the at least one item of information representative of the determined relevant blocks comprising the generated relevance map.

Still according to a particular embodiment of the invention, the device further comprises obtaining means for obtaining the size of at least one block of the base layer, the at least one block whose size is obtained being considered as relevant or not as a function of the obtained size. Such a device is particularly adapted to the Intra coding mode.

Still according to a particular embodiment of the invention, the device further comprises obtaining means for obtaining at least one motion vector of at least one block of the base layer, the at least one block whose motion vector is obtained being considered as relevant or not as a function of the obtained motion vector. Such a device is particularly adapted to the Inter coding mode.

Still according to a particular embodiment of the invention, the device further comprises estimating means for estimating at least one residual value based on the at least one block whose motion vector is obtained and on at least one predicted block based on at least one obtained motion vector. Such a device is particularly adapted to the case according to which the motion vector is estimated on a rate-distortion basis.

Still according to a particular embodiment, the at least one residual value is estimated as a function of a type of motion estimation applied to the at least one block whose motion vector is obtained, the type of motion estimation being encoded as a flag within the video stream.

Still according to a particular embodiment of the invention, the device further comprises comparing means for comparing at least one obtained motion vector with statistical motion data relating to the image to be encoded. Such a device is particularly adapted to the case according to which the motion vector characterizes a real motion.

Still according to a particular embodiment of the invention, the device further comprises up-sampling means for up-sampling a generated relevance map to encode at least one enhancement layer into at least two distinct groups of blocks independently decodable.

Still according to a particular embodiment of the invention, the generating means for generating a relevance map comprise creating means for creating at least one region of interest comprising a set of relevant blocks. The device may further comprise expanding means for expanding at least one region of interest as a function of a minimum size and/or discarding means for discarding at least one generated region of interest that is contained within at least one bigger generated region of interest.

Still according to a particular embodiment of the invention, the encoding means for encoding at least one enhancement layer comprise encoding means for encoding blocks that do not correspond to any region of interest of the relevance map and for encoding blocks that correspond to at least one region of interest of the relevance map.

According to another aspect of the invention, there is provided a device for decoding at least one image of a video stream in a block-based scalable video format, the encoded image comprising an encoded base layer and at least one encoded enhancement layer, the device comprising:
determining means for determining relevant blocks in the base layer according to a given criterion that depends on video data; and
decoding means for decoding at least a part of the at least one enhancement layer as a function of at least one item of information representative of determined relevant blocks.

According to this aspect of the invention, it is provided a spatial random access to an encoded video stream, with a reduced overhead in terms of bitrate and without requiring the decoding of the whole stream.

According to a particular embodiment of the invention, the device further comprises generating means for generating a relevance map based on determined relevant blocks, the at least one item of information representative of determined relevant blocks comprising the generated relevance map.

Still according to a particular embodiment of the invention, the determining means for determining relevant blocks comprise obtaining means for obtaining the size of at least one block of the base layer, the at least one block whose size is obtained being considered as relevant or not as a function of the obtained size. Such a device is particularly adapted to the Intra decoding mode.

Still according to a particular embodiment of the invention, the determining means for determining relevant blocks comprise obtaining means for obtaining at least one motion vector of at least one block of the base layer, the at least one block whose motion vector is obtained being considered as relevant or not as a function of the obtained motion vector. Such a device is particularly adapted to the Inter decoding mode.

Still according to a particular embodiment of the invention, the determining means for determining relevant blocks comprise estimating means for estimating at least one residual value based on at least one block whose motion vector is obtained and on at least one predicted block based on at least one obtained motion vector. Such a device is particularly adapted to the case according to which the motion vector is estimated on a rate-distortion basis.

Still according to a particular embodiment, the at least one residual value is estimated as a function of a type of motion estimation applied to the at least one block whose motion vector is obtained, the type of motion estimation being encoded as a flag within the video stream.

Still according to a particular embodiment of the invention, the determining means for determining relevant blocks comprise comparing means for comparing at least one obtained motion vector with statistical motion data relating to the image to be decoded. Such a device is particularly adapted to the case according to which the motion vector characterizes a real motion.

Still according to a particular embodiment of the invention, the device further comprises up-sampling means for up-sampling a generated relevance map to decode at least a part of the at least one enhancement layer.

Still according to a particular embodiment of the invention, the generating means for generating a relevance map comprise creating means for creating at least one region of interest comprising a set of relevant blocks.

Still according to a particular embodiment of the invention, the device further comprises expanding means for expanding at least one region of interest as a function of a minimum size and/or discarding means for discarding at least one generated region of interest that is contained within at least one bigger generated region of interest.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 graphically illustrates an example of a functional architecture of a video encoder, adapted to implement an embodiment of the invention, comprising a base video coder and an enhancement video coder;

FIG. 2 graphically illustrates an example of a functional architecture of a video decoder, comprising a base video decoder and an enhancement video decoder, adapted to receive and decode a video bit-stream produced by a video encoder such as the one illustrated in FIG. 1;

FIG. 3 is a schematic block diagram of a video encoder adapted to infer regions of interest from images of a video stream to be encoded;

FIG. 4, comprising FIGS. 4a, 4b, and 4c, illustrates an example of image encoding;

FIG. 5 illustrates some of the main steps of the block relevance computation of FIG. 3;

FIG. 6 illustrates steps for analysing the most relevant blocks as obtained from an algorithm such as the one illustrated in FIG. 5 to build one or more regions of interest that are used to determine the bit-stream organization of the spatial enhancement layer according to an embodiment of the invention;

FIG. 7, comprising FIGS. 7a, 7b, and 7c, illustrates an example of determination of regions of interest in an image;

FIG. 8 illustrates an example of slice header structure for ROI access;

FIG. 9 is a block diagram schematically illustrating a data communication system in which one or more embodiments of the invention may be implemented; and

FIG. 10 is a block diagram illustrating components of a processing device in which one or more embodiments of the invention may be implemented.

### DETAILED DESCRIPTION OF EMBODIMENTS OF THE INVENTION

Spatial access to particular image areas of video compressed bit-streams is not easy due to current video codecs that mainly focus on compression efficiency, thus heavily relying on spatial and temporal predictors. The counterpart to such a high compression efficiency is the strong dependencies between neighbour blocks of encoded images. In order to introduce some flexibility in the video access, some codecs provide scalable representations by encoding the video into multiple layers so that one can select the most appropriate one in terms of bandwidth, complexity, spatial or temporal resolution, etc. However, the scalability remains at the frame level and does not provide standard solutions for direct (i.e. without transcoding) random spatial access.

In a particular embodiment, the invention provides a stream organization that enables granular content adaptive spatial access according to which blocks corresponding to potential regions of interest are coded without dependencies upon other blocks whereas blocks outside potential regions of interest (ROI) can be grouped and coded differentially to improve the compression ratio.

The method according to this embodiment is based on estimation from the base layer bit-stream of potential candidate blocks for ROI. Such estimation is used in an enhancement layer as an input command to the entropy coder having the task of coding the quantized DCT (discrete cosine transform) coefficients. It provides a good trade-off between compression efficiency and spatial access granularity and it is compliant with CAVLC (Context-Adaptive Variable-Length Coding) and/or CABAC (Context-Adaptive Binary Arithmetic Coding) entropy encoders provided that context is reset for each new group of blocks.

The encoded video stream enables spatial random access with a reduced overhead in terms of bitrate (the compression is close to that provided by entropy coding), without requiring the decoding of the whole stream. According to this embodiment, only Intra coded frames are considered in the enhancement layer. Moreover, to cope with spatial dependencies that are used in context adaptive entropy coders, the macro-block organization in the enhancement layer is controlled by using information inferred from the base layer. Finally, regarding transmission issues, a content adaptive decomposition is obtained by analysing bit-stream parameters from the base layer.

According to this particular embodiment, a decoder infers ROIs as they are inferred by an encoder, from the base layer, the inferred ROIs being next up-sampled so as to provide a decoding order of the macro-blocks in the enhancement layer.

Therefore, the method according to this embodiment allows spatial access into compressed video streams that minimizes the overhead for ROI description and that does not require full decoding of the bit-stream. Indeed, there is no requirement to transmit any additional ROI information since ROIs are inferred from encoded data in the base layer. Furthermore, the method according to this embodiment does not require computational image analysis to identify potential ROIs. Finally, it provides an adaptive access granularity since blocks of ROIs are grouped into small sets of macro-blocks while blocks of non-ROIs are grouped into bigger sets of macro-blocks. According to a particular embodiment, region merging can be controlled by a parameter encoded for the whole video sequence to indicate the minimum acceptable size for a ROI (e.g. SD resolution for UHD streams or CIF resolution for HD streams).

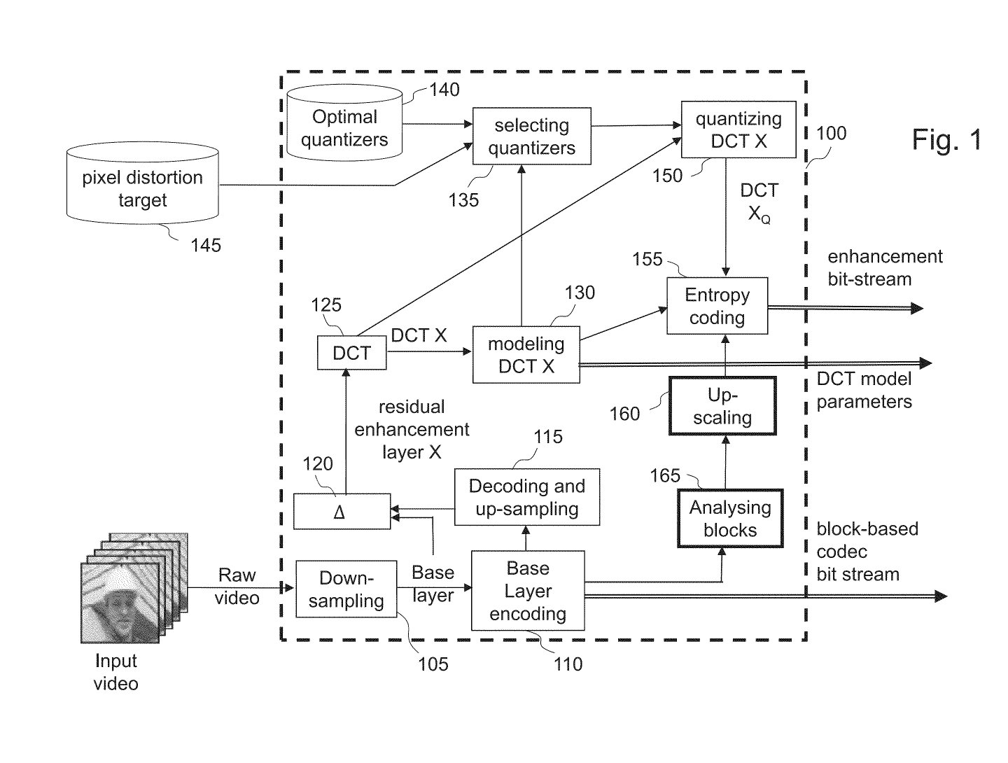

FIG. 1 graphically illustrates an example of a functional architecture of a video encoder 100, adapted to implement an embodiment of the invention, comprising a base video coder and an enhancement video coder.

As illustrated, the images of an input raw video stream are down-sampled at step 105 to obtain a so-called base layer which is encoded at step 110 by a standard base video coder, for example an encoder of the H.264/AVC or HEVC type. The encoded base layer can be embedded within a base layer bit-stream which can be transmitted to a decoder.

Next, the encoded base layer is decoded and up-sampled at step 115 to obtain an up-sampled decoded base layer. The latter is subtracted at step 120 from the corresponding image of the original raw video stream, in the pixel domain, to obtain a residual enhancement layer, denoted residual enhancement layer X. The information contained in this residual enhancement layer X is the error resulting from the base layer encoding and up-sampling.

Next, a block division, for example an homogenous 8×8 block division, is applied to the residual enhancement layer X (naturally, other divisions can be used, in particular divisions with non-constant block size) and a DCT is applied to each block at step 125. This allows construction of a DCT X frame which is encoded by the enhancement video encoder.

The DCT X frame is used at step 130 to model the statistical distribution of the DCT coefficients by fitting a parametric probabilistic model for each DCT coefficient. These fitted models become the channel models of the

DCT coefficients and the fitted parameters of each model are output in the bit-stream coded by the enhancement layer encoder.

Based on the channel models, optimal quantizers are selected at step 135 in a set of pre-computed quantizers 140 dedicated to each parametric channel according to a pixel distortion target 145. Next, the chosen quantizers are used to quantize DCT X at step 150 to obtain a quantized DCT X denoted DCT X_{Q}. Finally, an entropy encoder is applied to the quantized DCT X at step 155 to compress data and generate the encoded DCT X which constitutes an enhancement layer bit-stream.

The video encoder 100 further comprises a step 160 of analysing blocks of the base layer and a step 165 of up-scaling the base layer as a function of the analysed blocks to control the entropy coding step 155. More particularly, according to a particular embodiment of the invention, the base layer is analysed to identify blocks that may belong to regions of interest, the organization of the enhancement stream, that is to say the entropy coding, being based on such regions of interest.

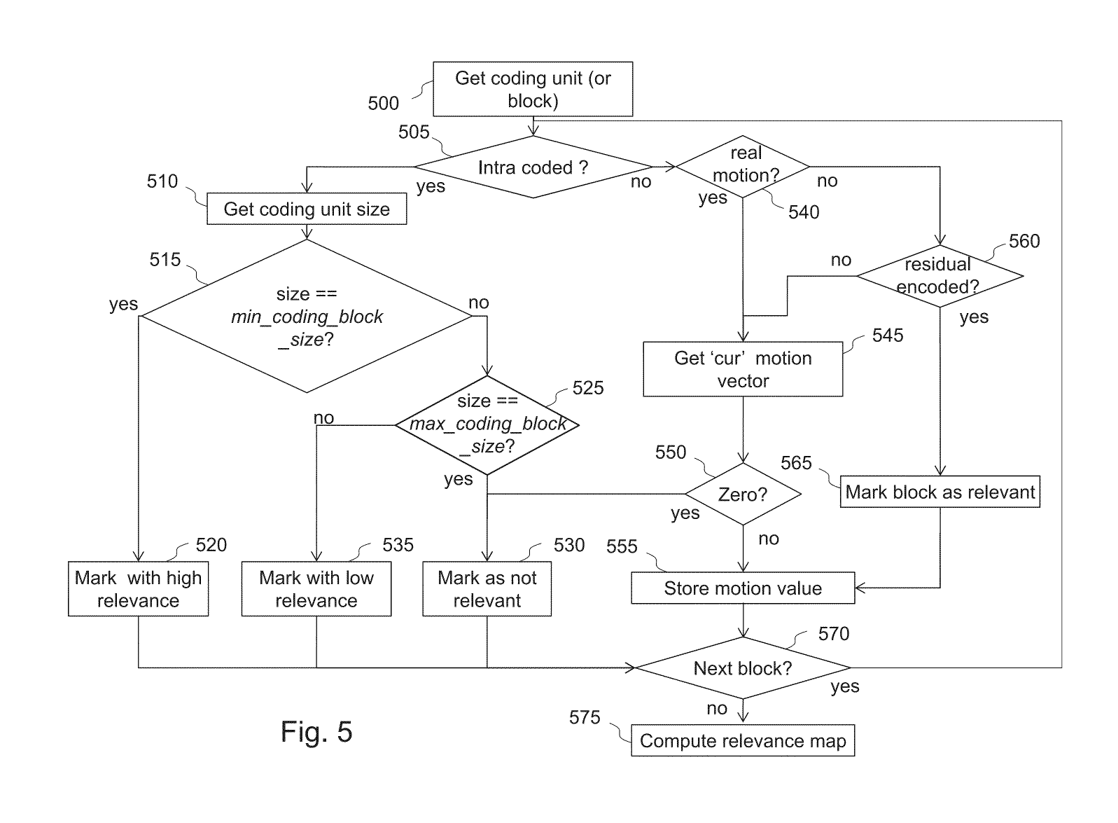

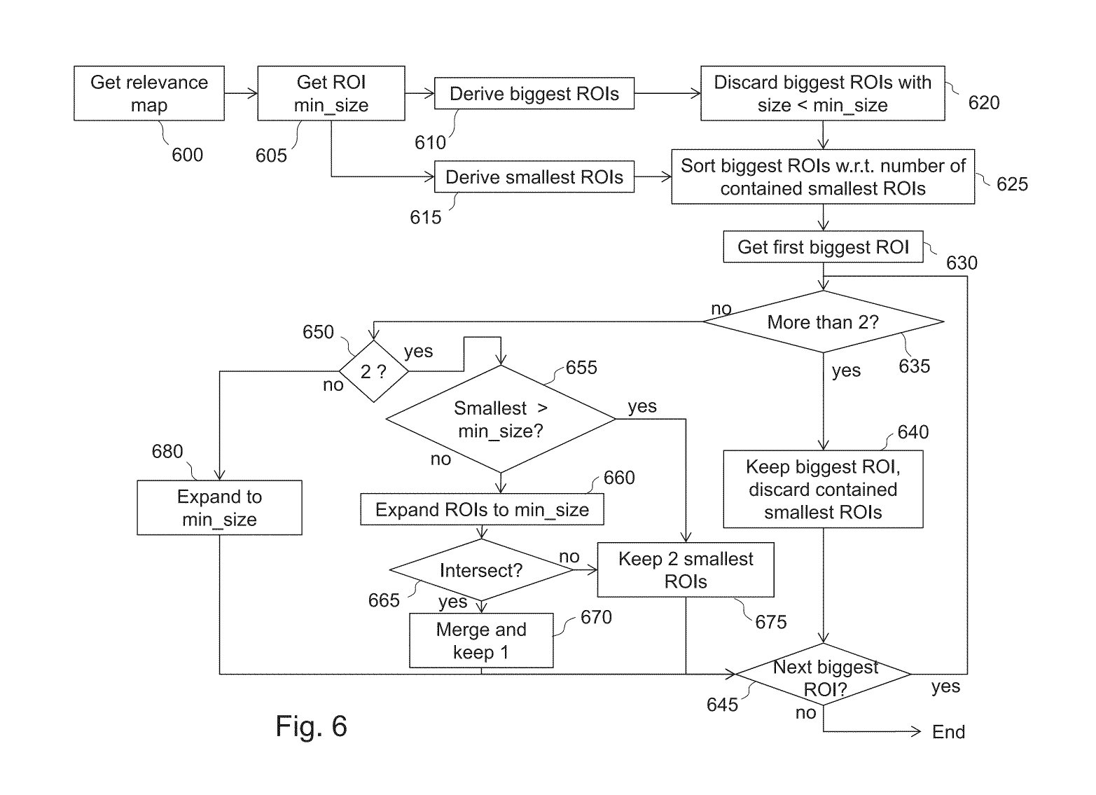

Steps 160 and 165 are described, in particular, by reference to FIGS. 5 and 6.

Accordingly, the encoding process as described by reference to FIG. 1 differs from well-known encoding process mainly at the entropy coder level. Indeed, while the processing order of blocks in the entropy coder is driven by regions of interest, in order to encode blocks slice by slice as a function of the regions of interest to which they belong, the transformation (DCT) and quantization are advantageously left unchanged (even if ROI inferred information could also be used to compute different quantization parameters for the blocks belonging to a ROI).

As illustrated, the encoded bit-stream produced by the video encoder 100 comprises:
a base layer bit-stream produced by the base video encoder;
an enhancement layer bit-stream encoded by the enhancement video encoder; and
parameters of channel models determined by the enhancement video encoder.

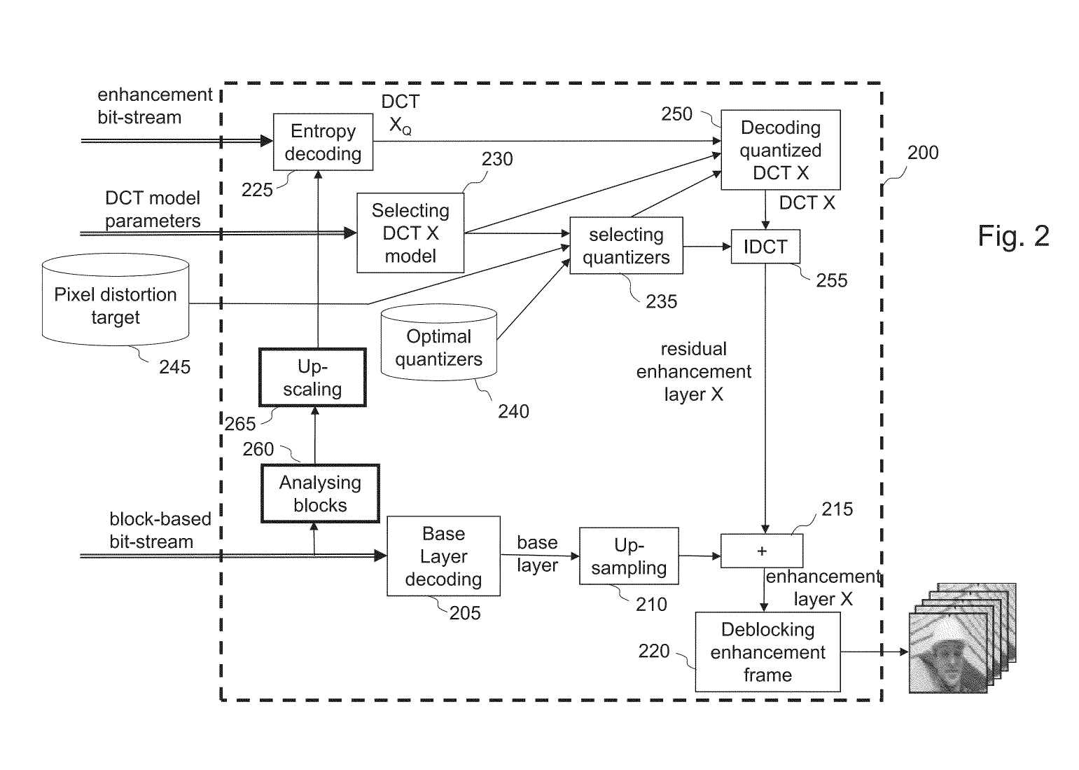

FIG. 2 graphically illustrates an example of a functional architecture of a video decoder 200, comprising a base video decoder and an enhancement video decoder, adapted to receive and decode a video bit-stream produced by a video encoder such as the one illustrated in FIG. 1.

The base layer bit-stream is received and decoded by the standard base video decoder to produce the decoded base layer. More precisely, the base layer is decoded at step 205 and up-sampled at step 210 so as to be added to a residual enhancement layer X at step 215. A post-processing filter such as a deblocking filter is preferably applied on the decoded enhancement frame at step 220 to produce an enhanced decoded frame.

At the same time, the enhancement layer bit-stream is decoded at step 225 to obtain a quantized DCT of an enhancement frame X (DCT X_{Q}), the channel models are reconstructed, and the statistical distribution model of the DCT coefficients of the enhancement frame X is determined at step 230. Based on this model, optimal quantizers are selected at step 235 from a set of pre-computed quantizers 240 dedicated to each parametric channel according to a pixel distortion target 245. Next, the obtained quantized DCT of the enhancement frame X is dequantized at step 250 as a function of the determined statistical distribution model of the DCT coefficients and as a function of the selected quantizers.

An inverse discrete cosine transform (IDCT) is applied on the DCT of the enhancement frame X at step 255, as a function of the selected quantizers, to obtain the residual enhancement layer X, in the pixel domain, that is added to the up-sampled base layer, as described above, to obtain the decoded enhancement layer.

As described above, the selection of blocks that may be used to determine regions of interest (referred to below as candidate blocks) and, consequently, determining the organization of a corresponding enhancement stream is carried out, according to a particular embodiment, as a function of the base layer's bit-stream parameters so that a decoder can infer the same candidate blocks from the received bit-stream as the encoder.

Other embodiments could consider video analysis prior to identifying candidate blocks in order to compute ROIs. However, this would require to embed data relative to ROI coordinates in the bit-stream, for example in user metadata placeholders, or to send such data in an additional metadata channel.

It should be noted that when a decoder can infer the same candidate blocks from the received base layer bit-stream as an encoder, transmission of additional information is not requested.

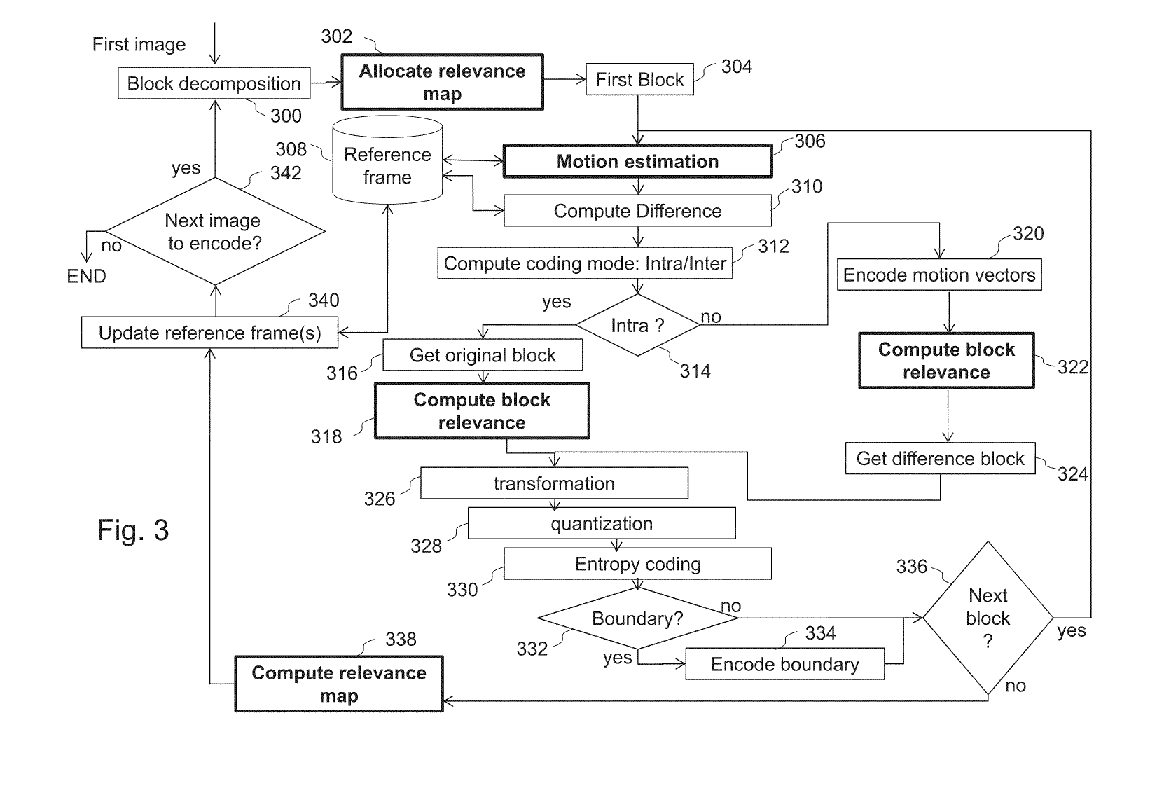

FIG. 3 is a schematic block diagram of a video encoder adapted to infer regions of interest from images of a video stream to be encoded, and more precisely from the base layer. It is close to one of a typical block-based video encoder for example according to MPEG-x standards, the main differences appearing in boxes having bold outline.

Compared to a typical block-based video encoder, the video encoder conforming to an embodiment of the invention mainly differs in that it comprises a step of computing block relevance and a step of computing a relevance map.

As illustrated in FIG. 3, after an image has been selected, the base layer is divided into blocks at step 300 and a relevance map is allocated at step 302.

The allocated relevance map can be considered as an image whose pixel values indicate whether or not the corresponding block is considered as relevant for computing a region of interest or whose pixel values are used to determine whether or not the corresponding block is to be considered as relevant for computing a region of interest. Each pixel of the relevance map corresponds to a block of the base layer.

Next, the first block is selected at step 304 to be processed and the motion vector characterizing the motion of the selected block as a function of a block of a reference frame 308 is estimated at step 306. Such a motion vector can be estimated in a standard way based on a rate-distortion criterion that minimizes a compression cost.

According to a particular embodiment, the encoder may comprise a specific motion estimation step allowing selection of realistic motion vectors, i.e.

motion vectors that represent the real displacement between the reference frame and the current frame to encode. Such a step replaces the standard step of selecting motion vectors on a rate-distortion criterion. It consists, on the encoder side, of selecting the block that minimizes the difference between the block to predict and the predictor. According to this particular embodiment, and in order to preserve a symmetric behaviour between an encoder and a decoder, a flag could be added in header information of the bit-stream (e.g. in a user data placeholder of SEI (Supplemental Enhancement Information) messages in HEVC) to indicate the motion estimation type. This flag would indicate that motion vectors are selected on their physical relevance rather than for their compression efficiency. This would provide additional information at block relevance computation time. Indeed, in such a case, motion vectors would become the most relevant criterion to extract regions of interests corresponding to moving objects.

After having determined a motion vector, the difference between the selected block and the estimated block is computed at step 310 and the coding mode, Intra or Inter, is computed at step 312.

If the coding mode is the Intra coding mode (step 314), the selected block is retrieved at step 316 to be encoded and the relevance of this block is computed at step 318. On the contrary, if the coding mode is the Inter coding mode (step 314), the motion vector is encoded at step 320, the relevance of the selected block is computed at step 322, and the difference between the selected block and the estimated block is retrieved at step 324 to be encoded.

Next, coding proceeds on a standard basis, typically with discrete cosine transformation (step 326), quantization (step 328), and entropy coding (step 330). A test is performed to determine whether or not a boundary needs to be encoded (steps 332 and 334).

If the selected block is not the last one of the base layer (step 336), the next block is selected and the previous steps (steps 306 to 336) are repeated. On the contrary, if the selected block is the last block of the base layer, the relevance map is computed at step 338 as described by reference to FIG. 5.

Next, the reference frames are updated at step 340 and a test is performed at step 342 to determine whether or not there is another image to encode. If the processed image is the last one, the process ends. Otherwise, the algorithm returns to step 300 to process a next image. For the sake of illustration, the HEVC standard is considered as the base layer bit-stream format in this embodiment. Other embodiments may be based on different standards that use block-based compression with spatial and temporal predictions as in HEVC.

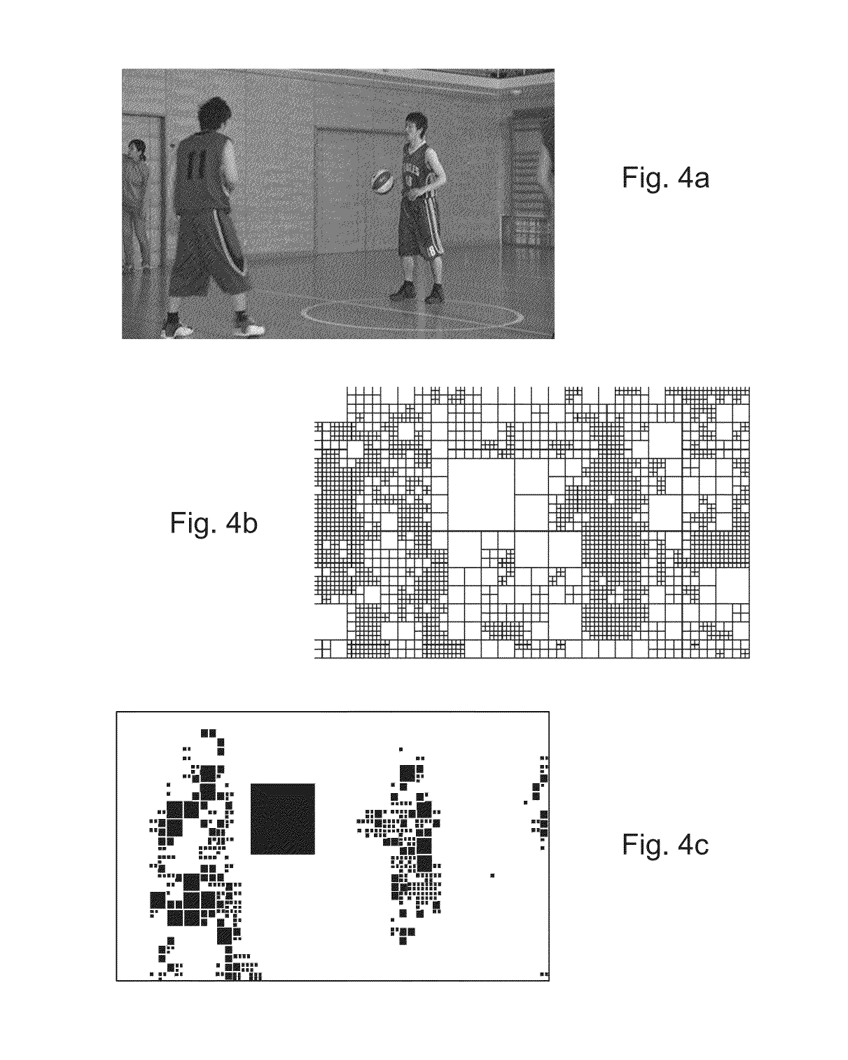

FIG. 4, comprising FIGS. 4a, 4b, and 4c, illustrates an example of an Intra frame decomposition of a frame to be coded (FIG. 4a) into transform units (FIG. 4b), i.e. the basis upon which the DCT is to be applied, and the different types of blocks of the corresponding Inter frame (FIG. 4c). White colour of FIG. 4b represents the Intra transform while black colour of FIG. 4c represents the Inter transform and white colour of FIG. 4c represents the blocks of the SKIP type.

As one can see in FIG. 4b, the smaller transform unit, the more it corresponds to an area with detail. Accordingly, the transform size of each block can be used to select the block as a candidate block to include in a region of interest.

Regarding Inter frames of FIG. 4c, skipped blocks do not appear to be good candidate blocks while Inter-coded and Intra-coded ones can be relevant.

FIG. 5 illustrates some of the main steps of the block relevance computation steps 318 and 322 of FIG. 3.

The same steps apply at the decoder end to infer the candidate blocks, the only difference being linked to the order of operations: block relevance computation at the encoder end occurs before computation of actual encoding parameters (e.g. coding mode, spatial predictors, quantized DCT coefficients, motion predictors, motion vectors, and so on) while at the decoder end, the block relevance computation occurs after decoding of parameters.

As illustrated, a first step 500 consists of selecting a coding unit or block to encode (or decode in the case of a decoder). It is to be recalled here that when considering an HEVC bit-stream, images are represented by one or more slices, each represented by a header followed by encoded data. Slice data are then represented in coding tree blocks which consist of a quadtree of coding units.

Next, a test is performed to determine whether the coding mode is Intra or Inter (step 505). Such a determination can be done as a function of a flag value, for example as a function of the pred_mode_flag value of the coding unit in the HEVC bit-stream.

As disclosed above, the level of decomposition is a good indicator of block relevance in Intra slices because it provides an estimation of the encoding complexity of the block. Accordingly, if the coding mode is Intra, the block relevance map built at both encoder and decoder ends reflects this decomposition. Blocks having the smallest decomposition level (i.e. the level given by parameter log2_min_coding_block_size_minus provided in a Sequence Parameter Set) are marked as highly relevant, while those that remain at the highest level are marked as not relevant and the remaining blocks are marked with low relevance.

To that end, the size of the coding unit or block is obtained at step 510 and compared with the minimum size of coding units or blocks (min_coding_block_size) at step 515. If the size of the coding unit or block is equal to the minimum size of coding units or blocks, the block is marked as being highly relevant (step 520).

On the contrary, if the size of the coding unit or block is different from the minimum size of coding units or blocks, it is compared with the maximum size of coding units or blocks (max_coding_block_size) at step 520, for example a size of 64×64 pixels. If the size of the coding unit or block is equal to the maximum size of coding units or blocks, the block is marked as being not relevant (step 530) and if the size of the coding unit or block is different from the maximum size of coding units or blocks, the block is marked as being not much relevant (step 535).

As disclosed above, motion information, providing information on moving objects in images, can be used efficiently, regarding block coding in Inter coding mode, to identify blocks that can be considered as good candidates to be part of regions of interest. Indeed, eyes are highly sensitive to moving objects and thus, moving objects draw the attention of eyes to themselves.

According to a particular embodiment, a first step of computation of block relevance for Inter coded blocks (step 540) is directed to determining whether the video stream is encoded using a rate-distortion oriented motion estimation or a real motion oriented motion estimation (as described above by reference to step 306 of FIG. 3).

If motion estimation is based on real motion, the motion value for the current block, obtained at step 545, is preferably the only criterion to determine the relevance of the current block, the determination being made in two steps. A first step is directed to the storage in the relevance map, for each block position, of the corresponding current motion vector value. A second step occurs during the step entitled “compute relevance map” in FIG. 3. During this step (which is performed after having processed all the blocks), the mean value and the standard deviation of motion values are computed. The so-computed standard deviation provides a dynamic (per image) and thus adaptive threshold on motion values. Blocks whose motion values are outside the computed standard deviation are marked as highly relevant while other blocks are marked as not relevant. It is to be noted that this threshold is preferably only determined from base layer bit-stream information at both encoder and decoder ends and that statistics regarding motion values are reset from one frame to another. Such a step of computing the relevance map is represented with reference 575.

Accordingly, if the motion value for the current block is zero (step 550), the block is marked as being not relevant (step 530). On the contrary, if the motion value for the current block is not zero, it is stored at step 555 so as to compute the relevance map later.

If motion estimation is based on rate-distortion (step 540), both motion vector and residual information are considered to compute block relevance. Therefore, a test is performed to determine whether or not residual information is to be coded (step 560). If residual information is to be coded, the block is marked as relevant at step 565 and its motion vector value is stored in the current relevance map at step 555.

If there is no residual information to be coded, the algorithm is returned to step 545 and the current block is handled as if the motion estimation is based on real motion.

Next, a test is performed to determine whether or not other coding units or blocks have to be processed (step 570).

After having processed all the blocks, the relevance map is processed as a function of the mean vector and the standard deviation (step 575), as described above, to finalize the selection of candidates blocks.

While FIG. 5 illustrates how to identify blocks as candidates of greater or lesser relevance for being part of a region of interest, FIG. 6 illustrates an example of steps for analysing the most relevant blocks as obtained from such an algorithm to build one or more regions of interest that are used to determine the bit-stream organization of the spatial enhancement layer according to an embodiment of the invention. In other words, FIG. 6 illustrates steps 338 of FIGS. 3 and 575 of FIG. 5 which are performed by both the encoder and the decoder. As mentioned above, the relevance map is computed for each frame of the video sequence

After having obtained at step 600 the relevance map built from the base layer during encoding or decoding of the coding units or blocks, the minimum size (min_size) of a region of interest is obtained at step 605.

Such a parameter can be obtained from an additional input encoded into user placeholders in SEI messages. Alternatively, when no such information is present, it can be hard-coded in both encoder and decoder. For the sake of illustration, the minimum size of a region of interest can be equal to H×W/64 where H and W respectively represent height and width of an image of the video stream.

Next, a biggest and a smallest ROI map is built from the relevance map at steps 610 and 615, respectively. The biggest ROI map is a ROI map built from the relevance map by considering all relevant blocks (high and low) while the smallest ROI map is built from the relevance map by considering only the highly relevant blocks.

According to a particular embodiment, ROIs in the ROI maps are obtained by considering bounding rectangles around the selected blocks so that holes surrounded by relevant blocks are merged into ROIs.

Next, the ROIs of the biggest ROI map that do not reach the minimum ROI size are discarded at step 620 and the remaining ROIs of the biggest ROI map are sorted at step 625 into different sets according to the presence of one, two, or more than two ROIs of the smallest ROI map in the considered ROI of the biggest ROI map.

A first ROI of the biggest ROI map is selected at step 630 and a test is performed to determine whether or not the selected ROI belongs to the set of ROIs comprising more than two ROIs of the smallest ROI map (step 635). If the selected ROI of the biggest ROI map comprises more than two ROIs of the smallest ROI map, the ROIs of the smallest ROI map comprised within the selected ROI of the biggest ROI map are discarded at step 640.

If the selected ROI of the biggest ROI map belongs to the set of ROIs comprising two ROIs of the smallest ROI map (step 650), another test is performed to determine whether or not the size of the two ROIs of the smallest ROI map is greater than the minimum ROI size (step 655). If the size of the two ROIs of the smallest ROI map is not greater than the minimum ROI size, the size of the two ROIs of the smallest ROI map comprised within the selected ROI is expanded to the minimum ROI size at step 660.

Next, a test is performed to determine whether or not the two extended ROIs intersect (step 665). If the two extended ROIs intersect, they are merged at step 670 into a single ROI whose bounding edge corresponds to the merger of the two extended ROIs. On the contrary, if the two extended ROIs do not intersect, they are kept as two distinct ROIs at step 675.

Finally, if the selected ROI of the biggest ROI map belongs to the set of ROIs comprising only one ROI of the smallest ROI map (step 650), the ROI of the smallest ROI map comprised within the selected ROI is expanded to the minimum ROI size at step 675.

After the current ROI has been processed, the next ROI of the biggest ROI map, if any, is selected at step 645 and the previous steps are repeated.

The remaining ROIs, either expanded or not, form the ROI map.

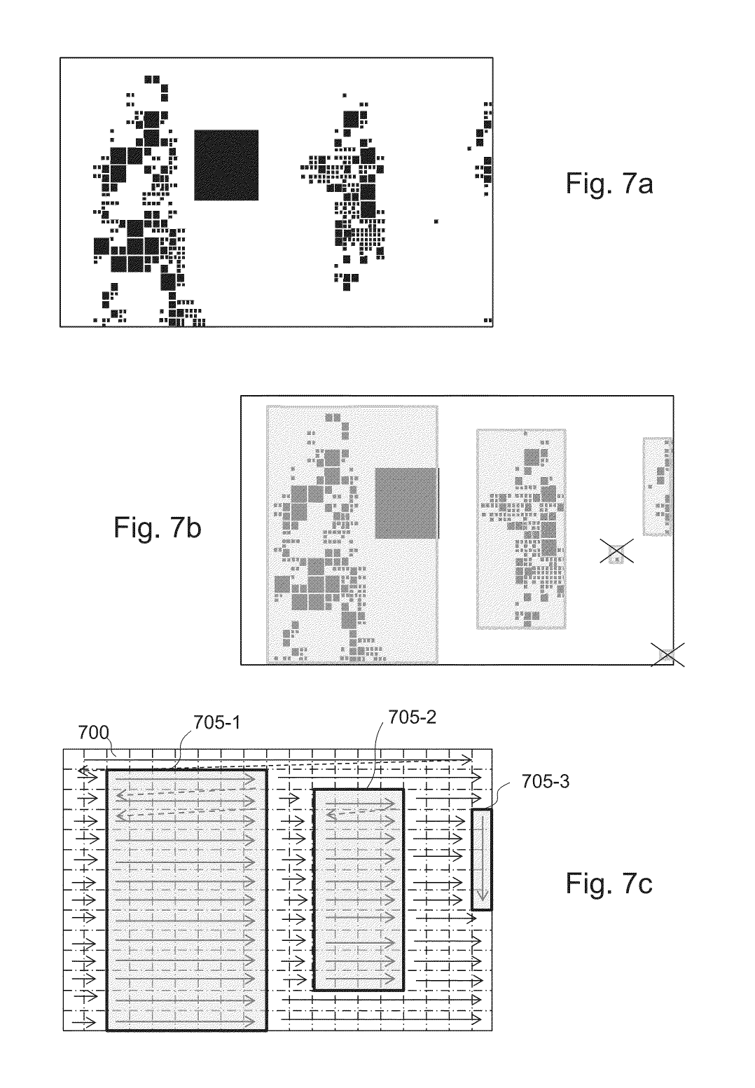

FIG. 7, comprising FIGS. 7a, 7b, and 7c, illustrates an example of determination of regions of interest in an image. FIG. 7b illustrates ROIs determined from FIG. 7a, which corresponds to FIG. 4c, according to the algorithm described by reference to FIG. 6. As illustrated, the smallest ROIs have been discarded.

According to a particular embodiment, a maximum number of ROIs is specified in a user data placeholder in a SEI message. In such a case, an additional step consists in gradually merging the smallest and closest candidate ROIs into one ROI until the maximum number is reached.

Still according to particular embodiments, regions of interest can be of arbitrary shapes (instead of considering the bounding rectangles of the relevant blocks). Moreover, it is possible to use previous estimated ROIs (for a previous frame) in the current frame to guide the merge operation of ROIs in order to maintain a constant number of regions across frames.

After having obtained ROI candidates in an ROI map, as illustrated in FIG. 7b, the ROI map is up-sampled to be used for encoding or decoding the spatial enhancement layer.

According to a particular embodiment, it is considered that encoding and decoding a spatial enhancement layer is based on a regular block decomposition as illustrated in FIG. 7c that represents the influence of the regions of interest as defined in FIG. 7b for scanning blocks during encoding and decoding.

More precisely, the residual enhancement layer X obtained at step 120 in FIG. 1, is divided into blocks, for example 8×8 pixel blocks (other divisions may be considered). Next, a DCT is applied onto each of the blocks that are quantized and grouped in macro-blocks (a very common case for so-called 4:2:0 YUV video streams is a macro-block made of four blocks of luminance Y, one block of chrominance U and one block of chrominance V). Next, the macro-blocks are entropy coded in a sequence order determined as a function of the ROI map.

It should be noted that the up-sampling of the ROI map is advantageously rounded upwards so that the ROI borders fall onto macro-block borders.

Accordingly, the ROI candidates as defined by an algorithm such as the one described by reference to FIG. 6 have an impact on the entropy coder and decoder and on the data signalization. For example, regarding the example given in FIGS. 4 and 7, all blocks pertaining to the background are arranged into one set of blocks (typically a slice in MPEG terminology) while the blocks corresponding to the regions of interest as illustrated in FIG. 7b are arranged into other sets of blocks (one set of blocks being used for each region of interest). Alternatively, a set of blocks can be created or terminated each time the coder or the decoder encounters a ROI border. However, such an embodiment would induce a lower compression rate, especially for a context adaptive entropy coder/decoder due a greater number of context resets from one slice to another.

The entropy encoder operates on a block basis, quantized DCT coefficients of blocks being provided at the input of the entropy coder. Another input of the entropy coder is the position of the current block with respect to the ROI map so as to encode blocks from the background and next, blocks from a first region of interest and next, blocks of a second region of interest and so on.

Accordingly, regarding the example of FIGS. 4 and 7, the encoder would process each block of the first line of blocks of the image that, according to the ROI map (FIG. 7c), belong to background and move to the second line of blocks. When processing the second block of the second line, the system would determine that the block belongs to a region of interest by looking at the ROI map (FIG. 7c) and thus, skip the coding of that block. Similarly, the following blocks would be skipped until the tenth that belongs to the background according to the ROI map. Therefore, after having coded the first block of the second line, the entropy coder would move to the tenth block to encode it. The process continues similarly until the last block of the last line of the current frame so as to encode the blocks belonging to the background.

Next, the blocks of the first region of interest, in lexicographical order, are encoded similarly, and then the ones of the second region of interest and so on.

It should be noted that the video encoder could also use multiple entropy encoders in parallel to process simultaneously blocks from different ROIs or from the background. The number of required parallel entropy encoders could be determined as a function of the ROI map.

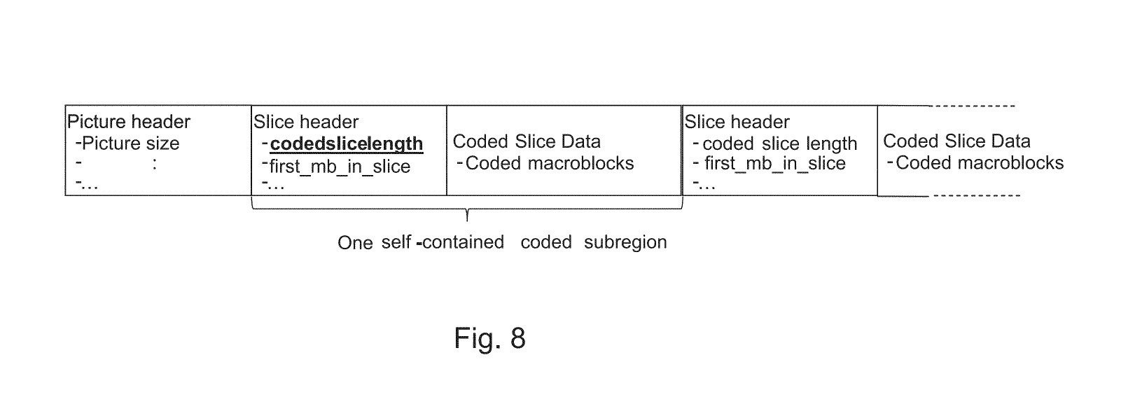

Encoded blocks from the background and from one ROI to another are advantageously separated by a slice header as illustrated in FIG. 8. For each slice header containing ROI data, the length (typically in bytes) of the slice, denoted coded_slice_length, is given as well as the position of the first macro-block in that slice, denoted first_mb_in_slice. This enables easy navigation and extraction of bit-stream from one slice to another and then to retrieve the bits for compressed ROIs. Compared to a standard regular grid decomposition, no overhead is introduced (only the length of the slice and the position of the first macro-block are required).

Regarding the decoder, the reverse process is to be applied: when parsing an input bit-stream for the spatial enhancement layer, the entropy decoder also looks at the ROI map obtained from the base layer. When a slice header is encountered, the entropy decoder is reset and the first_mb_in_slice field of the slice header indicates to the entropy decoder whether that slice corresponds to a ROI or not. Depending on the relationship between the first macro-block and the candidate ROIs, the entropy decoder decodes the blocks and their positions according to the scanning order (as described by reference to FIG. 7c).

It should be noted that the part(s) of the enhancement layer to be decoded can be automatically determined or can be determined by a user of the device displaying the video stream, typically a receiver, as a function of a selection of a region of interest in the base layer. In such a case, the base layer is advantageously displayed and the user selects an area of the displayed sequence of images to select a region of interest whose corresponding enhancement layer part is decoded.

Therefore, the use of a ROI map allows a video bit-stream for the enhancement layer to be compliant with spatial random access. In a particular embodiment, the access granularity is limited to the slice granularity, wherein the slice organization is determined by the candidate ROI map. Other embodiments offer finer granularity access by providing, for example, macro-block-based access. However, such solutions would require to signal the position of each macro-block in the bit-stream. Another solution avoiding any syntax for the localisation of the ROI consists in entropy decoding the macro-blocks until reaching the macro-blocks of the ROI. These macro-blocks are identified thanks to the ROI map.

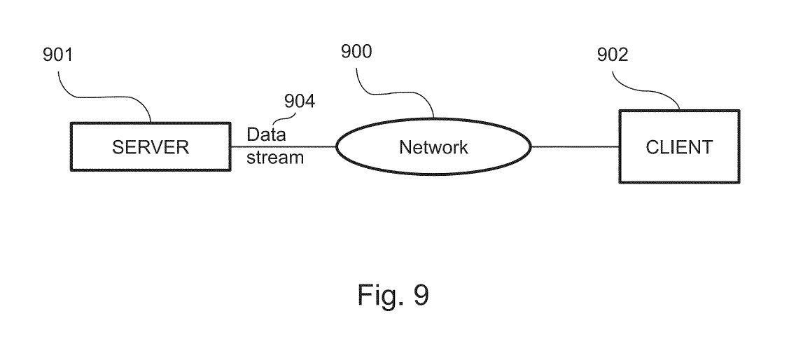

FIG. 9 illustrates a data communication system in which one or more embodiments of the invention may be implemented. The data communication system comprises a transmission device, in this case a server 901, which is operable to transmit data packets of a data stream to a receiving device, in this case a client terminal 902, via a data communication network 900. The data communication network 900 may be a Wide Area Network (WAN) or a Local Area Network (LAN). Such a network may be for example a wireless network (Wifi/802.11a or b or g), an Ethernet network, an Internet network or a mixed network composed of several different networks. In a particular embodiment of the invention the data communication system may be a digital television broadcast system in which the server 901 sends the same data content to multiple clients.

The data stream 904 provided by the server 901 may be composed of multimedia data representing video and audio data. Audio and video data streams may, in some embodiments of the invention, be captured by the server 901 using a microphone and a camera respectively. In some embodiments data streams may be stored on the server 901 or received by the server 901 from another data provider, or generated at the server 901. The server 901 is provided with an encoder for encoding video and audio streams in particular to provide a compressed bitstream for transmission that is a more compact representation of the data presented as input to the encoder.

In order to obtain a better ratio of the quality of transmitted data to quantity of transmitted data, the compression of the video data may be for example in accordance with the scalable video encoder described by reference to FIG. 1.

The client 902 receives the transmitted bitstream and decodes the reconstructed bitstream to reproduce video images on a display device and the audio data by a loudspeaker.

Although a streaming scenario is considered in the example of FIG. 9, it will be appreciated that in some embodiments of the invention the data communication between an encoder and a decoder may be performed using for example a media storage device such as an optical disc.

In one or more embodiments of the invention a video image is transmitted with data representing of compensation offsets for application to reconstructed pixels of the image to provide filtered pixels in a final image.

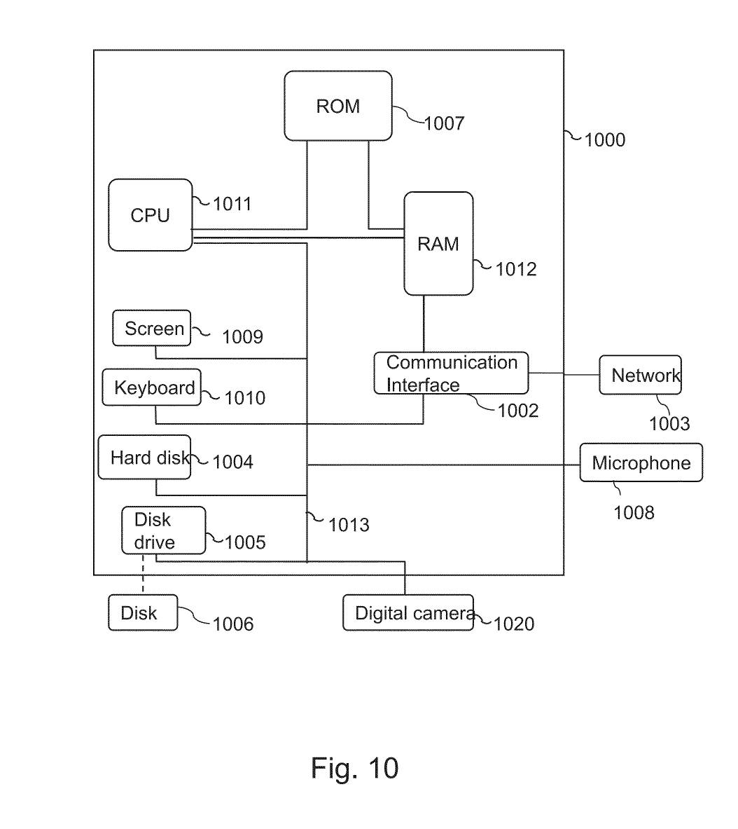

FIG. 10 schematically illustrates a processing device 1000 configured to implement at least one embodiment of the present invention. The processing device 1000 may be a device such as a micro-computer, a workstation or a light portable device. The device 1000 comprises a communication bus 1013 connected to:
a central processing unit 1011, such as a microprocessor, denoted CPU;

a read only memory 1007, denoted ROM, for storing computer programs for implementing the invention;

a random access memory 1012, denoted RAM, for storing the executable code of the method of embodiments of the invention as well as the registers adapted to record variables and parameters necessary for implementing the method of encoding a sequence of digital images and/or the method of decoding a bitstream according to embodiments of the invention; and
a communication interface 1002 connected to a communication network 1003 over which digital data to be processed are transmitted or received

Optionally, the apparatus 1000 may also include the following components:
a data storage means 1004 such as a hard disk, for storing computer programs for implementing methods of one or more embodiments of the invention and data used or produced during the implementation of one or more embodiments of the invention;
a disk drive 1005 for a disk 1006, the disk drive being adapted to read data from the disk 1006 or to write data onto said disk;
a screen 1009 for displaying data and/or serving as a graphical interface with the user, by means of a keyboard 1010 or any other pointing means.

The apparatus 1000 can be connected to various peripherals, such as for example a digital camera 1020 or a microphone 1008, each being connected to an input/output card (not shown) so as to supply multimedia data to the apparatus 1000.

The communication bus provides communication and interoperability between the various elements included in the apparatus 1000 or connected to it. The representation of the bus is not limiting and in particular the central processing unit is operable to communicate instructions to any element of the apparatus 1000 directly or by means of another element of the apparatus 1000.

The disk 1006 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of encoding a sequence of digital images and/or the method of decoding a bitstream according to the invention to be implemented.

The executable code may be stored either in read only memory 1007, on the hard disk 1004 or on a removable digital medium such as for example a disk 1006 as described previously. According to a variant, the executable code of the programs can be received by means of the communication network 1003, via the interface 1002, in order to be stored in one of the storage means of the apparatus 1000 before being executed, such as the hard disk 1004.

The central processing unit 1011 is adapted to control and direct the execution of the instructions or portions of software code of the program or programs according to the invention, instructions that are stored in one of the aforementioned storage means. On powering up, the program or programs that are stored in a non-volatile memory, for example on the hard disk 1004 or in the read only memory 1007, are transferred into the random access memory 1012, which then contains the executable code of the program or programs, as well as registers for storing the variables and parameters necessary for implementing the invention.

In this embodiment, the apparatus is a programmable apparatus which uses software to implement the invention. However, alternatively, the present invention may be implemented in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

For example, it should be noted that even though the previous description may focus on spatial enhancement layer made up of Intra frames, the invention can be implemented with an enhancement layer using P or B frames provided that for the enhancement layer (base layer would remain standard), from one frame to another, the motion estimator also uses the ROI map to constrain the motion vectors for the blocks of one ROI to only reference blocks from the corresponding ROI in reference images and does not use cross layer prediction.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for encoding at least one image of a video stream in a block-based scalable video format, the encoded image comprising an encoded base layer and at least one encoded enhancement layer, the method comprising:
determining relevant blocks in the encoded base layer according to a given criterion that depends on video data; and
encoding the at least one enhancement layer into at least two distinct groups of blocks independently decodable, as a function of at least one item of information representative of the determined relevant blocks.

2. The method of claim 1 further comprising a step of generating a relevance map based on the determined relevant blocks, the at least one item of information representative of the determined relevant blocks comprising the generated relevance map.

3. The method of claim 1 wherein the step of determining relevant blocks comprises a step of obtaining the size of at least one block of the base layer, the at least one block whose size is obtained being considered as relevant or not as a function of the obtained size.

4. The method of claim 1 wherein the step of determining relevant blocks comprises a step of obtaining at least one motion vector of at least one block of the base layer, the at least one block whose motion vector is obtained being considered as relevant or not as a function of the obtained motion vector.

5. The method of claim 4 wherein the step of determining relevant blocks comprises a step of estimating at least one residual value based on the at least one block whose motion vector is obtained and on at least one predicted block based on the at least one obtained motion vector.

6. The method of claim 5 wherein the step of estimating at least one residual value is performed as a function of a type of motion estimation applied to the at least one block whose motion vector is obtained.

7. The method of claim 6 wherein the type of motion estimation is encoded as a flag within the video stream.

8. The method of claim 4 wherein the step of determining relevant blocks comprises a step of comparing at least one obtained motion vector with statistical motion data relating to the image to be encoded.

9. The method of claim 8 wherein the statistical motion data comprises a mean value and a standard deviation of motion values of each of a plurality of blocks of the image to be encoded.

10. The method of claim 2 further comprising a step of up-sampling the generated relevance map to encode the at least one enhancement layer into at least two distinct groups of blocks independently decodable.

11. The method of claim 2 wherein the step of generating a relevance map comprises a step of creating at least one region of interest comprising a set of relevant blocks.

12. The method of claim 11 further comprising a step of expanding the at least one region of interest as a function of a minimum size.

13. The method of claim 11 further comprising a step of discarding at least one generated region of interest that is contained within at least one bigger generated region of interest.

14. The method of claim 11 wherein the step of encoding the at least one enhancement layer comprises a first step of encoding blocks that do not correspond to any region of interest of the relevance map and at least one second step of encoding blocks that correspond to at least one region of interest of the relevance map.

15. A device for encoding at least one image of a video stream in a block-based scalable video format, the encoded image comprising an encoded base layer and at least one encoded enhancement layer, the device comprising:
determining means for determining relevant blocks in the encoded base layer according to a given criterion that depends on video data; and
encoding means for encoding the at least one enhancement layer into at least two distinct groups of blocks independently decodable, as a function of at least one item of information representative of determined relevant blocks.

16. A device for decoding at least one image of a video stream in a block-based scalable video format, the encoded image comprising an encoded base layer and at least one encoded enhancement layer, the device comprising:
determining means for determining relevant blocks in the base layer according to a given criterion that depends on video data; and
decoding means for decoding at least a part of the at least one enhancement layer as a function of at least one item of information representative of determined relevant blocks.

17. The device of claim 16 further comprising generating means for generating a relevance map based on determined relevant blocks, the at least one item of information representative of determined relevant blocks comprising the generated relevance map.

18. The device of claim 16 wherein the determining means for determining relevant blocks comprise obtaining means for obtaining the size of at least one block of the base layer, the at least one block whose size is obtained being considered as relevant or not as a function of the obtained size.

19. The device of claim 16 wherein the determining means for determining relevant blocks comprise obtaining means for obtaining at least one motion vector of at least one block of the base layer, the at least one block whose motion vector is obtained being considered as relevant or not as a function of the obtained motion vector.

20. The device of claim 19 wherein the determining means for determining relevant blocks comprise comparing means for comparing at least one obtained motion vector with statistical motion data relating to the image to be decoded.
